(19) United States
(12) Patent Application Publication
(10) Pub. No.: US 2011/0292927 A1
(43) Pub. Date: Dec. 1, 2011

(54) UPLINK RECEIVING APPARATUS OF OFDMA SYSTEM BASED ON LTE AND FREQUENCY SYNCHRONIZATION METHOD THEREOF

(75) Inventors: Joo Hyun LEE, Daejeon (KR); Bon Tae Koo, Daejeon (KR); Hee Bum Jung, Daejeon (KR)

(73) Assignee: Electronics and Telecommunications Research Institute, Daejeon (KR)

(21) Appl. No.: 13/116,450

(22) Filed: May 26, 2011

(30) Foreign Application Priority Data
May 27, 2010 (KR) 10-2010-0049824
Feb. 25, 2011 (KR) 10-2011-0017241

(51) Int. Cl. H04W 88/02; H04W 56/00

(52) U.S. Cl. 370/350; 370/310

(57) ABSTRACT

Provided are an uplink receiving device of a long term evolution (LTE)-based orthogonal frequency division multiplexing access (OFDMA) system, and a method of synchronizing a frequency thereof. The uplink receiving device includes a fast Fourier transform (FFT) processing unit eliminating a cyclic prefix (CP) from an OFDM uplink signal to perform a fast Fourier transform (FFT); a subcarrier extraction unit performing a subcarrier extraction operation with regard to an output of the FFT processing unit to thus only extract a signal of a specific terminal unit; and an inverse discrete Fourier transform (DFT) processing unit performing an inverse DFT on an output of the subcarrier extraction unit to generate a time domain signal.

### CROSS-REFERENCE TO RELATED APPLICATIONS

This application claims the priority of Korean Patent Application Nos. 10-2010-0049824 filed on May 27, 2010 and 10-2011-0017241 filed on Feb. 25, 2011, in the Korean Intellectual Property Office, the disclosures of which are incorporated herein by reference.

### BACKGROUND OF THE INVENTION

1. Field of the Invention

The present invention relates to an uplink receiving device, and more particularly, to an uplink receiving device applied to a long term evolution (LTE)-based orthogonal frequency division multiplexing access (OFDMA) system.

2. Description of the Related Art

In an LTE-based OFDMA system, a frequency interval between subcarriers is relatively small as compared to a transmission band, and since an orthogonality of respective subcarriers should be maintained at the time of a transmission, the LTE-based OFDMA system is very sensitive to a frequency offset as compared to a single carrier system.

Thus, in a case in which a frequency offset is generated due to non-matching occurring in an oscillator for a transmission and receiving period or a doppler shift, since a receiving function may be greatly degraded, an accurate estimation for the frequency offset and a compensation process therefor are indispensably required in an uplink receiving device, a base station device.

FIG. 1 is a block diagram of an uplink receiving device according to the related art.

Referring to FIG. 1, each of a plurality of uplink receiving devices 100-1 to 100-N may include a filter 110, a frequency offset estimation unit 120, an offset compensation unit 130, a fast Fourier transform (FFT) processing unit 140, and the like.

All of a plurality of terminal units 11 to 1N respectively include a frequency offset ε and a timing offset δ as well as each channel, and thus, only a signal of a corresponding terminal unit should be separately selected in order to demodulate a signal of a corresponding terminal unit in orthogonal frequency division multiplexing (OFDM) uplink signals.

Thus, the filter 110 only extracts an OFDM signal of a corresponding terminal unit from an OFDM uplink signal in which all of a plurality of OFDM signals generated by the plurality of terminal units 11 to 1N have been mixed.

Then, the frequency offset estimation unit 120 and the offset compensation unit 130 estimate a frequency offset by using a cyclic prefix (CP) of the OFDM signal extracted through the filter 110 and continuously compensate threfor.

Thereafter, the FFT processing unit 140 receives a signal frequency-synchronized by the frequency offset estimation unit 120 and the offset compensation unit 130 and removes the CP of the signal, to thus perform an FFT and demodulate the OFDM signal.

FIG. 2 illustrates a frequency offset estimation process of an uplink receiving device according to the related art.

As shown in FIG. 2, the frequency offset estimation unit 120 according to the related art estimates a frequency offset through an amount of change in a phase within two sections by using characteristics in which second halves of a protection section and an effective symbol section in a time domain are the same as each other, in a case of OFDM signal.

That is, when the OFDM signal is y(n) in the time domain, a frequency offset \hat{ε}_{f} using the CP (or a protection section N_{GI}) is estimated according to the following mathematical expression 1.

$$Mathematical Expression 1$$

$${\hat{ɛ}}_{f} = \frac{1}{2 π} {tan}^{- 1} \{ \frac{{\sum }_{n = 0}^{{N}_{GI} - 1} Im [ y * ( {N}_{FFT} + n ) y ( n ) ]}{{\sum }_{n = 0}^{{N}_{GI} - 1} Re [ y * ( {N}_{FFT} + n ) y ( n ) ]} \}$$

Here, ‘n’ denotes a sample index of an OFDM signal, 0<n<N_{GI}−1 a protection section, and N_{GI}<n<N_{FFT}+N_{GI} an effective symbol section.

As such, in the plurality of uplink receiving devices 100-1 to 100-N, the uplink receiving devices 100-1 to 100-N may be prevented from deteriorating in reception performance in advance by extracting the OFDM signal of a corresponding terminal unit through the filter 110 that requires a very large hardware capacity to thus estimate and compensate for a frequency offset thereof.

However, since the filter 110 provided with the plurality of uplink receiving devices 100-1 to 100-N requires a very large capacity of a hardware, the number of terminal units to be supported is limited according to a capacitance of the hardware of the filter 110. Therefore, when the number of the terminal units to be supported by the plurality of uplink receiving devices 100-1 to 100-N is increased, the number of the filters 110 should be also increased.

That is, the plurality of uplink receiving devices 100-1 to 100-N according to the related art have a defect in which a relatively large amount of hardware capacity is required due to the use of the filter 110.

### SUMMARY OF INVENTION

An aspect of the present invention provides an uplink receiving device capable of performing a newly applicable signal extraction scheme substituted for a filter signal extraction operation, by using a relatively reduced hardware capacity, thereby significantly reducing a magnitude of hardware in an uplink receiving device.

According to an aspect of the present invention, there is provided an uplink receiving device including: an FFT processing unit eliminating a CP from an OFDM uplink signal to perform a FFT; a subcarrier extraction unit performing a subcarrier extraction operation with regard to an output of the FFT processing unit to thus only extract a signal of a specific terminal unit; and an inverse discrete fourier transform (DFT) processing unit performing an inverse DFT on an output of the subcarrier extraction unit to generate a time domain signal.

The uplink receiving device may further include a frequency offset estimation unit estimating a frequency offset from a correlation between an output of the inverse DFT processing unit and an output of the subcarrier extraction unit; and an offset compensation unit compensating for the frequency offset contained in the OFDM uplink signal by using the frequency offset.

The frequency offset estimation unit may estimate the frequency offset according to an expression

$$″ {\hat{ɛ}}_{f} = \frac{1}{π} {tan}^{- 1} ( {xcor}_{f}^{*} \cdot {xcor}_{B} ) , {xcor}_{F} = {\sum }_{n = 0}^{M / 2 - 1} {r}^{*} ( n ) \cdot x ( n ) , \\ {xcor}_{B} = {\sum }_{n = M / 2}^{M - 1} {r}^{*} ( n ) \cdot x ( n ) ″$$

wherein r*(n) indicates a conjugate signal of an output from the inverse DFT processing unit, x(n) denotes an OFDM signal, M indicates a signal length of an output from the inverse DFT processing unit, xcor_{F} indicates a signal sum result from a multiplication-result signal pertaining to a 0<n<M/2−1 signal section, xcor_{B} designates a signal sum result from a multiplication-result signal pertaining to an M/2<n<M−1 signal section, and \hat{ε}_{f} denotes the frequency offset.

The uplink receiving device may further include a loop filter bypassing the frequency offset of the frequency offset estimation unit to the offset compensation unit when the frequency offset has an initial value, and when the frequency offset is not the initial value, computing a difference of the frequency offset to thus inform the offset compensation unit of the computed difference of the frequency offset.

According to another aspect of the present invention, there is provided a method of synchronizing a frequency of an uplink receiving device, the method including: eliminating a CP from an OFDM uplink signal to perform a fast fourier transform (FFT); performing a subcarrier extraction operation with regard to an FFT processing result to thus only extract a signal of a specific terminal unit; performing an inverse DFT for a subcarrier extraction output to generate a time domain signal; estimating a frequency offset from a correlation between an output of the inverse DFT execution output and the subcarrier extraction output; and compensating for the frequency offset contained in the OFDM uplink signal by using the frequency offset.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an uplink receiving device according to the related art;

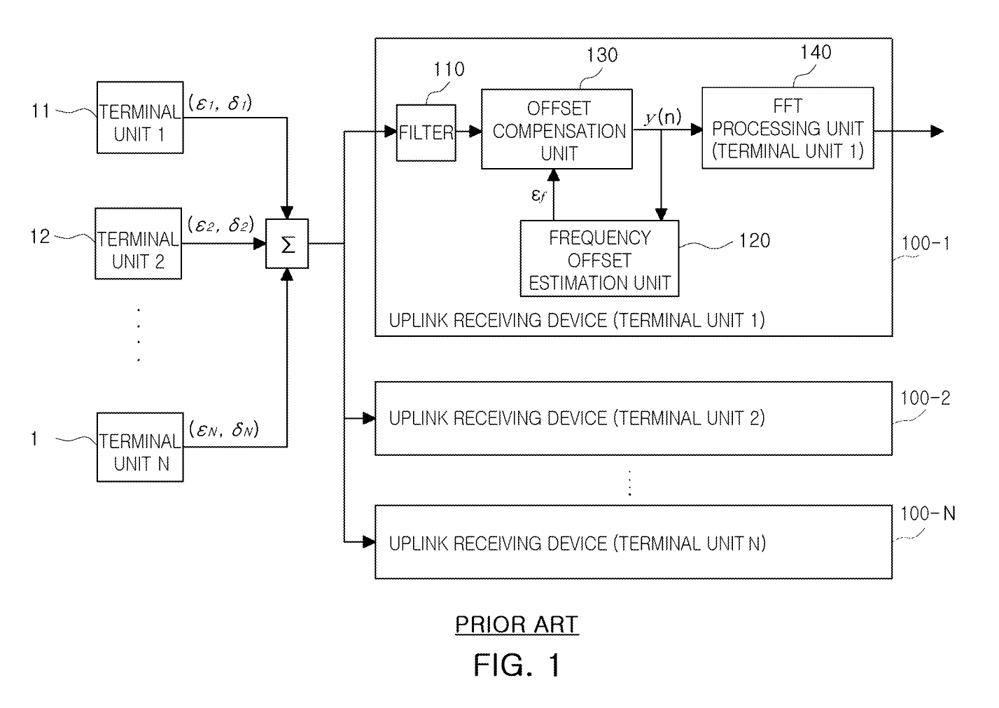

FIG. 2 illustrates a frequency offset estimation process of an uplink receiving device according to the related art;

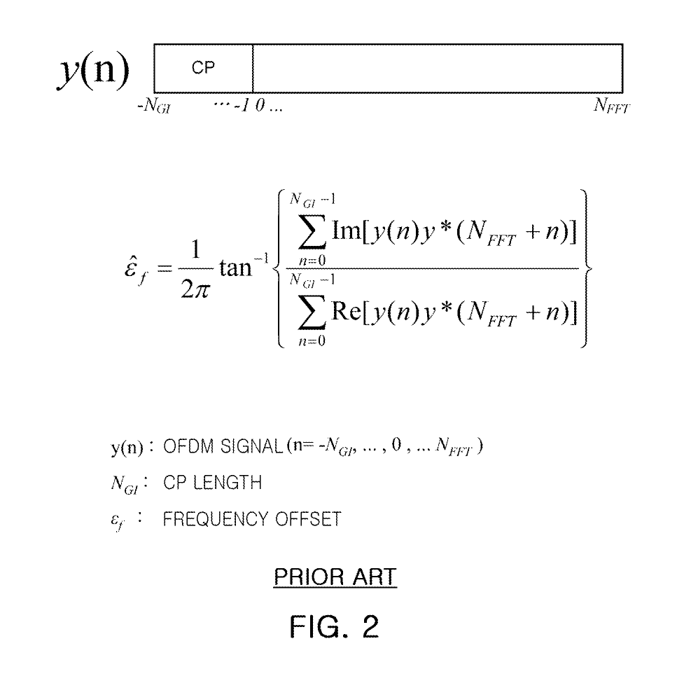

FIG. 3 is a block diagram of an uplink receiving device according to an embodiment of the present invention;

FIG. 4 illustrates a frequency offset estimation process according to an embodiment of the present invention; and

FIG. 5 is a flowchart illustrating a frequency synchronization method of an uplink receiving device according to an embodiment of the present invention.

### DETAILED DESCRIPTION OF THE INVENTION

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

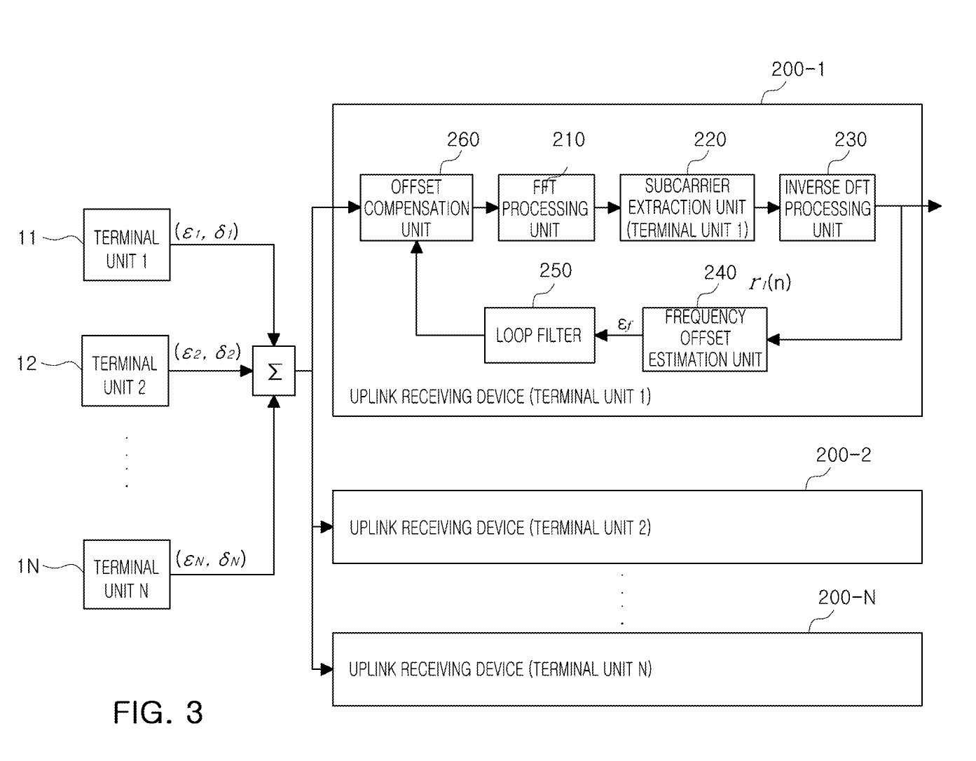

FIG. 3 is a block diagram of an uplink receiving device according to an embodiment of the present invention.

With reference to FIG. 3, each of uplink receiving devices 200-1 to 200-N may include an FFT processing unit 210, a subcarrier extraction unit 220, and an inverse discrete fourier transform (DFT) processing unit 230, a frequency offset estimation unit 240, a loop filter 250, an offset compensation unit 260, and the like.

That is, the uplink receiving device 200 may be provided with the omission the filter 110 according to the related art, and may perform a signal extraction operation using a relatively simple arithmetic operation in the FFT processing unit 210, the subcarrier extraction unit 220, and the inverse DFT processing unit 230, thereby significantly decreasing a hardware capacity required for a signal extraction operation.

Meanwhile, in the above-described configuration, an FFT operation may be first performed and then a frequency offset estimation operation may be performed. In this case, a CP is removed during a process in which the FFT operation is performed such that the frequency offset estimation operation using the CP according to the related art cannot be executed. Therefore, according to an embodiment of the present invention, a frequency offset estimation method based on a time domain in which the CP is not used, may additionally be proposed.

Hereinafter, functions of respective configurative elements will be described.

The FFT processing unit 210 may eliminate a CP of an OFDM uplink signal to then perform an FFT operation and thus demodulate the OFDM signal.

The subcarrier extraction unit 220 may execute a subcarrier extraction operation based on a frequency band used by a corresponding terminal unit to selectively only extract an OFDM signal of the corresponding terminal unit among output signals from the FFT processing unit 210.

The inverse DFT processing unit 230 may perform an inverse DFT with regard to the signal extracted through the subcarrier extraction unit 220 to convert the signal into a signal r(n) of a time domain. Here, the time domain signal is a pilot signal previously recognized by the uplink receiving device 200. In addition, the inverse DFT processing unit 230 may convert a signal of a frequency domain into a time domain-based signal, whereby the frequency offset estimation unit 240 may perform a frequency offset estimation operation using the converted time domain-based signal.

The frequency offset estimation unit 240 may estimate a frequency offset of a specific terminal unit from a correlation between an output signal of the inverse DFT processing unit 230 and an input signal, an OFDM signal of a corresponding terminal unit, of the inverse DFT processing unit 230.

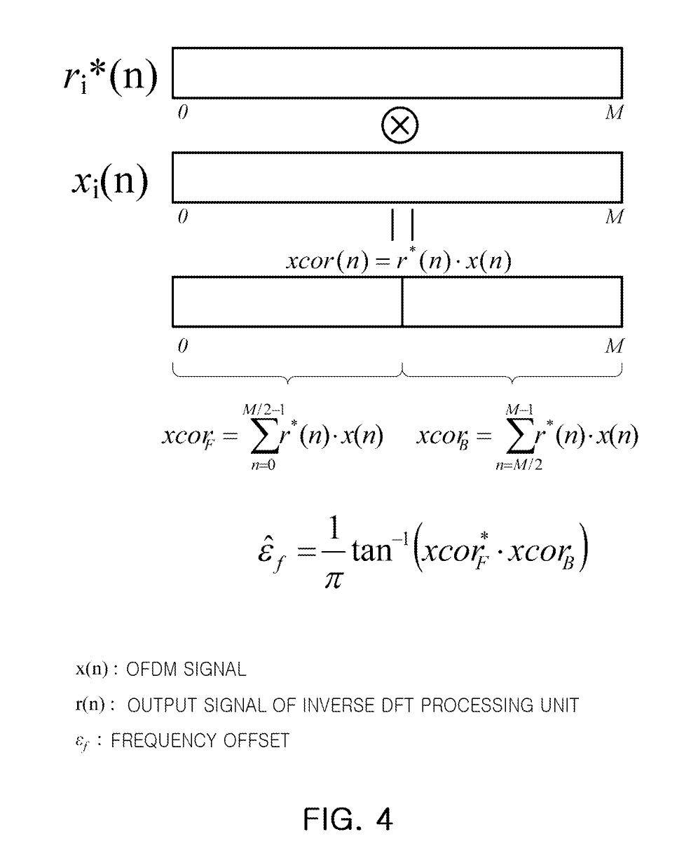

In more detail, as shown in FIG. 4, the frequency offset estimation unit 240 may generate a conjugate signal r*(n) with regard to the signal r(n) of the time domain, and after that, may remove the pilot signal by multiplying the conjugate signal r*(n) by an OFDM signal x(n) such that only a frequency offset component is left. Subsequently, a multiplication-result signal r*(n)·x(n) may be equivalently divided into two sections, and then, each section signal summing operation may be performed, and respective section signal sums may be multiplied by each other. Thereafter, a frequency offset of a corresponding terminal unit may be estimated from a phase provided with respect to the multiplied result, which may appear as the following mathematical expression 2.

$${\hat{ɛ}}_{f} = \frac{1}{π} {tan}^{- 1} ( {xcor}_{F}^{*} \cdot {xcor}_{B} ) \\ {xcor}_{F} = {\sum }_{n = 0}^{M / 2 - 1} {r}^{*} ( n ) \cdot x ( n ) \\ {xcor}_{B} = {\sum }_{n = M / 2}^{M - 1} {r}^{*} ( n ) \cdot x ( n ) \qquad Mathematical Expression 2$$

Here, M denotes a signal length of an output of the inverse DFT processing unit 230, a length of a signal r(n) of a time domain, and xcor_{F} denotes a signal sum result of multiplication-result signals pertaining to a 0<n<M/2−1 signal section, and xcor_{B} indicates a signal sum result of multiplication-result signals pertaining to an M/2<n<M−1 signal section.

The loop filter 250 may operate so that a frequency offset \hat{ε}_{f} initially estimated by the frequency offset estimation unit 240 is bypassed to the offset compensation unit 260, and from a next estimation value, the loop filter 250 may inform the offset compensation unit 260 of a difference of the frequency offset \hat{ε}_{f}. As such, the operation in which the loop filter 250 directly bypasses the initial frequency offset \hat{ε}_{f} to the offset compensation unit 260 may be performed to remove a settling delay caused due to a closed loop feedback of the loop filter 250.

The offset compensation unit 260 may compensate for a frequency offset of the OFDM uplink signal input to each of the uplink receiving devices 200-1 to 200-N by using a frequency offset \hat{ε}_{f} provided through the loop filter 250 or a difference of the frequency offset \hat{ε}_{f} to thus provide a frequency-synchronized signal to the FFT processing unit 210.

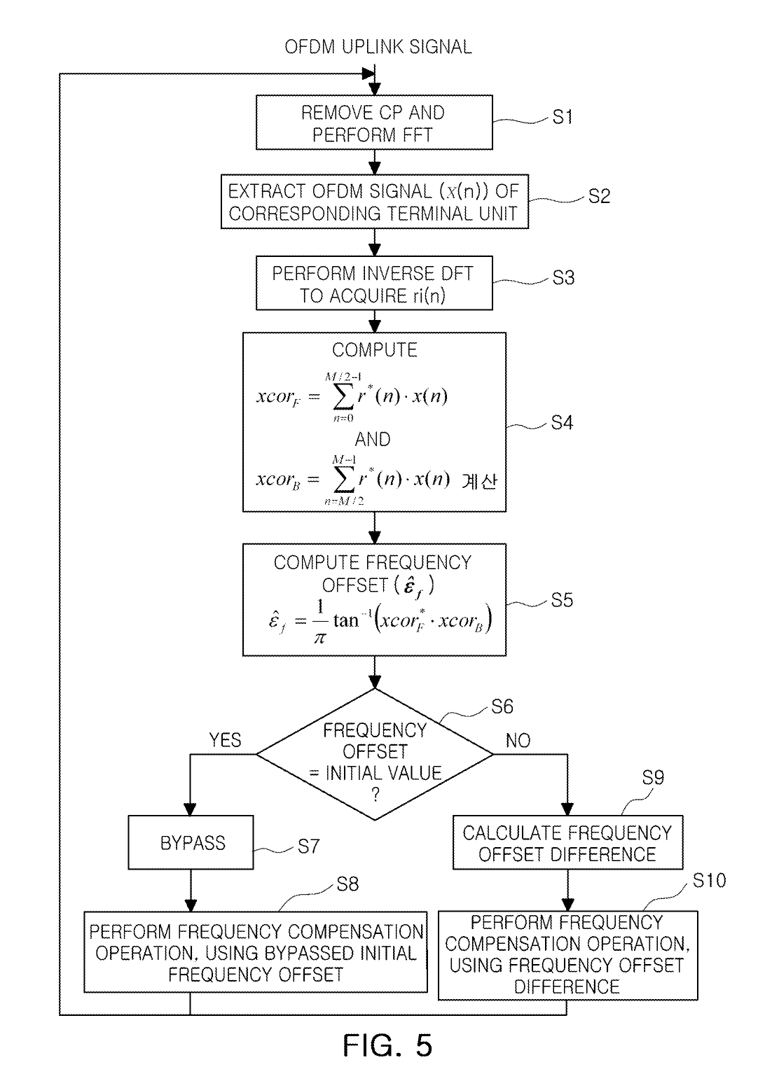

FIG. 5 is a flowchart illustrating a frequency synchronization method of an uplink receiving device according to an embodiment of the present invention.

First, when an OFDM uplink signal is input to each of the uplink receiving devices 200-1 to 200-N, the FFT processing unit 210 may remove the CP of the OFDM uplink signal thereto to perform an FFT and demodulate the OFDM signal in operation S1.

Thereafter, the subcarrier extraction unit 220 may perform a subcarrier extraction operation according to a preset frequency band to thus selectively only extract an OFDM signal of a corresponding terminal unit.

Then, the inverse DFT processing unit 230 may perform an inverse DFT with regard to the signal extracted through the subcarrier extraction unit 220 to thus convert the OFDM signal of a corresponding terminal unit into the signal r(n) of a time domain in operation S3.

Subsequently, the frequency offset estimation unit 240 may multiply the conjugate signal r*(n) of an output signal r(n) from the inverse DFT processing unit 230 by the OFDM signal x(n), and then, a multiplication-result signal r*(n)·x(n) may be equivalently divided into two sections, and summing operation may be then performed for each section signal. That is, a summing operation

$${xcor}_{F} = {\sum }_{n = 0}^{M / 2 - 1} {r}^{*} ( n ) \cdot x ( n )$$

for the multiplication-result signals corresponding to the 0<n<M/2−1 signal section, and a summing operation

$${xcor}_{B} = {\sum }_{n = M / 2}^{M - 1} {r}^{*} ( n ) \cdot x ( n )$$

for the multiplication-result signals corresponding to the M/2<n<M−1 signal section may be respectively performed in operation S4.

Thereafter, respective section signal sum results

$${xcor}_{F} = {\sum }_{n = 0}^{M / 2 - 1} {r}^{*} ( n ) \cdot x ( n ) and {xcor}_{B} = {\sum }_{n = M / 2}^{M - 1} {r}^{*} ( n ) \cdot x ( n )$$

may be multiplied by each other, and then, a frequency offset of a corresponding terminal unit may be estimated as

$${\hat{ɛ}}_{f} = \frac{1}{π} {tan}^{- 1} ( {xcor}_{F}^{*} \cdot {xcor}_{B } )$$

from a phase provided from the multiplied result xcor_{F}*·xcor_{B}, in operation S5.

When the frequency offset \hat{ε}_{f} estimated through operation S5 is an initial value, the loop filter 250 may bypass the offset to the offset compensation unit 260, and the offset compensation unit 260 may perform a frequency compensation operation according to the initial frequency offset in operation S7.

Meanwhile, when the frequency offset estimated through operation S5 is not an initial value, the loop filter 250 may compare a previous frequency offset \hat{ε}_{f} with a current frequency offset \hat{ε}_{f} to calculate a frequency difference, in operation S8, and the offset compensation unit 260 may perform a frequency compensation operation using the of the frequency offset in operation S9.

While the present invention has been shown and described in connection with the embodiments in the, it will be apparent to those skilled in the art that modifications and variations can be made without departing from the spirit and scope of the invention as defined by the appended claims.

As set forth above, according to embodiments of the present invention, an uplink receiving device may perform a signal extraction operation, using a relatively simple arithmetic operation scheme in an FFT processing unit, a subcarrier extraction unit and an inverse DFT processing unit, by omitting a filter according to the related art, thereby greatly reducing a hardware capacity required for a signal extraction operation. Accordingly, an uplink receiving device according to the embodiments of the present invention may have an overall reduction in hardware.

While the present invention has been shown and described in connection with the embodiments described herein, it will be apparent to those skilled in the art that modifications and variations can be made to the present invention without departing from the spirit and scope thereof, as defined by the appended claims.

What is claimed is:

1. An uplink receiving device comprising:
a fast Fourier transform (FFT) processing unit eliminating a cyclic prefix from an orthogonal frequency division multiplexing (OFDM) uplink signal to perform a fast Fourier transform (FFT);
a subcarrier extraction unit performing a subcarrier extraction operation with regard to an output of the FFT processing unit to thus only extract a signal of a specific terminal unit; and
an inverse discrete Fourier transform (DFT) processing unit performing an inverse DFT on an output of the subcarrier extraction unit to generate a time domain signal.

2. The device of claim 1, further comprising:
a frequency offset estimation unit estimating a frequency offset from a correlation between an output of the inverse DFT processing unit and an output of the subcarrier extraction unit; and
an offset compensation unit compensating for the frequency offset contained in the OFDM uplink signal by using the frequency offset.

3. The device of claim 2, wherein the frequency offset estimation unit estimates the frequency offset according to an expression
$${}_{″}^{}{\hat{ɛ}}{}_{f}^{} = \frac{1}{π} {tan}^{- 1} ( {xcor}_{F}^{*} \cdot {xcor}_{B} ) , {xcor}_{F} = {\sum }_{n = 0}^{M / 2 - 1} {r}^{*} ( n ) \cdot x ( n ) , \\ {xcor}_{B} = {\sum }_{n = M / 2}^{M - 1} {r}^{*} ( n ) \cdot {x ( n )}_{″} ,$$
wherein r*(n) indicates a conjugate signal of an output from the inverse DFT processing unit, x(n) denotes an OFDM signal, M indicates a signal length of an output from the inverse DFT processing unit, xcor_{F} indicates a signal sum result from a multiplication-result signal pertaining to a 0<n<M/2−1 signal section, xcor_{B} designates a signal sum result from a multiplication-result signal pertaining to an M/2<n<M−1 signal section, and \hat{ε}_{f} denotes the frequency offset.

4. The device of claim 2, further comprising a loop filter bypassing the frequency offset of the frequency offset estimation unit to the offset compensation unit when the frequency offset has an initial value, and when the frequency offset is not the initial value, computing a difference of the frequency offset to thus inform the offset compensation unit of the computed difference of the frequency offset.

5. A method of synchronizing a frequency of an uplink receiving device, the method comprising:
eliminating a cyclic prefix from an OFDM uplink signal to perform an FFT;
performing a subcarrier extraction operation with regard to an FFT processing result to thus only extract a signal of a specific terminal unit;
performing an inverse DFT for a subcarrier extraction output to generate a time domain signal;
estimating a frequency offset from a correlation between an output of the inverse DFT execution output and the subcarrier extraction output; and
compensating for the frequency offset contained in the OFDM uplink signal by using the frequency offset.
